(19) United States
(12) Patent Application Publication
(10) Pub. No.: US 2009/0151816 A1
(43) Pub. Date: Jun. 18, 2009

(54) Adjustable Work Benches for Power Tools

(76) Inventors: Ross A. Billings, Baltimore, MD (US); Richard C. Nickels, JR., Hampstead, MD (US); Jason F. Busschaert, Towson, MD (US); William E. Hawkins, Millersville, MD (US)

Correspondence Address: THE BLACK & DECKER CORPORATION, 701 EAST JOPPA ROAD, TW199, TOWSON, MD, 21286, US

(21) Appl. No.: 12/331,858

(22) Filed: Dec. 10, 2008

Related U.S. Application Data
(60) Provisional application No. 61/013,266, filed on Dec. 12, 2007.

(51) Int. Cl. B25H 1/00

(52) U.S. Cl. 144/287

(57) ABSTRACT

A work bench for a power tool includes a beam for supporting the power tool, the beam having a first end, a second end, and a top surface extending between the first and second ends, and legs for supporting the beam over a surface. The work bench includes a first extension arm extendable from the first end of the beam, the first extension arm including a first main arm that telescopes within the first end of the beam, a first auxiliary arm that telescopes within the first main arm, and a first support leg that is pivotally connected with the auxiliary arm and that telescopes within the main arm. The work bench includes a second extension arm extendable from the second end of the beam, the second extension arm including a second main arm that telescopes within the second end of the beam, a second auxiliary arm that telescopes within the second main arm, and a second support leg that is connected with the second auxiliary arm and that telescopes within the second main arm.

### BACKGROUND OF THE INVENTION

1. Field of the Invention

The present invention generally relates to work benches and more particularly to a portable work bench adapted to support power tools and workpieces.

2. Description of the Related Art

It is common in the construction industry for users to bring their power tools to the work site. Thus, the users require a work surface at the work site to support the power tools for use. Preferably the work surface is at a certain height so that the user can comfortably use the power tool. In addition, the work surface should also be sufficiently portable to be easily moved around the work site.

In the past, users have positioned their power tools on sheets of wood which are, in turn, supported by two or more sawhorses. This arrangement, however, lacks the strength and stability for efficient operation, as well as being difficult to set up and move around the work site.

Accordingly, different support stands or work benches have been proposed in order to provide a portable work surface that can support a power tool. Some of these prior art solutions have been described in U.S. Pat. Nos. 1,864,840, 4,860,807, 4,874,025, 4,974,651, 5,193,598, and 5,421,231. The above-described work benches, however, are not able to adequately support workpieces having a substantial length.

In one or more embodiments of commonly assigned U.S. Pat. Nos. 6,745,804 and 7,036,540, the disclosures of which are hereby incorporated by reference herein, a work bench has a main beam and a pair of arms that extend from the main beam for supporting workpieces. Referring to FIG. 1, the work bench 20 includes a stand 22 and a miter saw 24 that is securable atop the stand 22.

Referring to FIGS. 2A and 2B, the stand 22 includes a main beam 25 having a first arm 26 and a second arm 28. The stand 22 has a first pair of support legs 30A, 30B and a second pair of support legs 32A, 32B for supporting the beam in a substantially horizontal configuration. The stand 22 also has a first extendable arm 34 and a second extendable arm 36. The stand includes a first locking knob (not shown) associated with the first extendable arm 34 and a second locking knob 38 in communication with the second extendable arm 36. The locking knobs may be loosened for moving the extendable arms 34, 36 relative to the main beam 24. When a desired position for the first and second extendable arms 34, 36 is obtained, the locking knobs are tightened to secure the extendable arms from further movement.

The stand 22 includes a first extension arm end cap 40 secured to a distal end of the first extension arm 34, a first workpiece support 42 coupled with the first extension arm end cap 40, and a stop 44 disposed at an upper end of the first workpiece support 42. The stand 22 includes a second extension arm end cap 40B secured to a distal end of the second extendable arm 36, a second workpiece support 42B connected with the second extension arm end cap 40B, and a stop 44B provided at an upper end of the second workpiece support.

Referring to FIGS. 1 and 2B, the system 20 includes the power tool 24, such as a miter saw 24, and a pair of mounting brackets 46A, 46B that are used for attaching the miter saw 24 to the main beam 25. The mounting brackets 46A, 46B enable the miter saw 24 to be secured to and movable along the main beam 25.

Referring to FIG. 2B, the miter saw 24 includes a table 48 having a top surface 50 that supports a workpiece during a cutting operation. The extendable arms 34, 36 provide additional support when the workpiece extends beyond the edge of the table 48. The ends of the workpiece are desirably supported by the workpiece supports 42A, 42B. When the workpiece is longer that the beam 25, the first and second workpiece supports 42A, 42B are moved away from one another for supporting the ends of the workpiece. In contrast, when the workpiece is shorter than the beam 25, the first and second workpiece supports 42A, 42B are moved toward one another.

FIG. 3 shows the stand of FIGS. 1-2B in an extended position. The extendable arms are extended away from the main beam 25. The first and second workpiece supports 42A, 42B provide support for the ends of the workpiece 54. A central portion of the workpiece 54 is supported by the top surface of the table 48. As shown in FIG. 3, if the workpiece 54 has a substantial length, the stops 44A, 44B (FIG. 2A) normally attached to the upper ends of the workpiece supports 42A, 42B may be removed. The workpiece supports 42A, 42B have upper ends that lie in a common plane with the top surface 50 of the table 48.

FIG. 4 shows the system 20 with the extendable arms in a collapsed or retracted position. In this configuration, the extendable arms are disposed within the main beam 25 of the stand 22. When in the collapsed position, the stand may be easily moved from one job site to another. Once the stand has been moved to a new job site, the extendable arms may be adjusted and/or extended to accommodate workpieces having various lengths.

In spite of the above advances, there remains a need for improved work benches for power tools having enhanced stability, that improve efficiency, that provide additional work areas atop the work bench, and that enable operators to easily store tools at the work bench.

### SUMMARY OF THE INVENTION

The present invention discloses a work bench for a power tool, such as a miter saw. The work bench preferably has a pair of extendable arms that are telescopically received within a central beam. The outer ends of the extendable arms include support legs that extend vertically to engage a surface such as the ground so as to improve the stability of the work bench. The upper ends of the support legs may be pivotally attached to the outer ends of the extendable arms. The extendable arms and the support legs associated therewith are completely retractable within the central beam of the work bench for facilitating movement of the work bench from one location to another.

In one embodiment, the work bench may include workpiece supporting elements that project upwardly from the extendable arms. A first workpiece supporting element may be provided on the first extendable arm and a second workpiece supporting element may be provided on the second extendable arm. The first and second workpiece supporting elements may have sloping surfaces that face one another. Although the present invention is not limited by any particular theory of operation, it is believed that the sloping surfaces enable an operator to more easily direct the drooping ends of a sagging workpiece atop the workpiece supporting elements.

In one embodiment, the work bench may have one or more tool storage containers attached thereto. The tool storage containers may be attached in an upright orientation atop the beam, or in an inverted orientation below the beam. The tool storage container may have a base and top cover that closes atop the base. The top cover and the base may be hingedly coupled together. The side walls of the base and the top cover desirably extend more than ½ of the height of the container so that the container may be effectively used for securing tools regardless of whether the container in upright or inverted.

In one embodiment of the present invention, a work bench for a power tool includes a beam having a first end and a second end, legs for supporting the beam, and a first extension arm extendable from the first end of the beam. The first extension arm includes a main arm that telescopes within the beam, an auxiliary arm that telescopes within the main arm, and a support leg that is connected with the auxiliary arm and that telescopes within the main arm. The support leg may be affixed in a vertical orientation relative to the auxiliary arm and the main arm to provide stabilizing support for the work bench.

In one embodiment, the support leg is pivotally connected with the auxiliary arm for moving between a retracted position and an extended position. The support leg may be length adjustable so that the support leg can be adjusted to contact the ground or a floor for stabilizing the work bench. In one embodiment, the support leg includes a first section pivotally connected with the auxiliary arm, a second section that telescopes within the first section, and a locking element in contact with the support leg having an unlocked position for adjusting the length of the support leg and a locked position for affixing the length of the support leg.

The main arm desirably has a distal end with at least one opening and the auxiliary arm and the support leg are receivable in the at least one opening. The main arm preferably includes a first internal compartment for storing the auxiliary arm and a second internal compartment for storing the support leg. The first and second internal compartments are desirably separated from one another by a wall that extends to the distal end of the main arm.

In one embodiment of the present invention, the work bench has a first locking element in communication with the main arm, the first locking element having an unlocked position for enabling telescoping movement of the main arm relative to the beam and a locked position for preventing telescoping movement of the main arm relative to the beam. The work bench may include a second locking element disposed on the main arm and being in communication with the auxiliary arm, the second locking element having an unlocked position for enabling telescoping movement of the auxiliary arm relative to the main arm and a locked position for preventing telescoping movement of the auxiliary arm relative to the main arm.

The work bench desirably includes a second extension arm extendable from the second end of the beam, the second extension arm including a second main arm that telescopes within the beam, a second auxiliary arm that telescopes within the second main arm, and a second support leg that is connected with the second auxiliary arm and that telescopes within the second main arm.

The second support leg is preferably pivotally connected with the second auxiliary arm. The second main arm desirably has a distal end with at least one opening and the second auxiliary arm and the second support leg are preferably receivable in the at least one opening of the second main arm.

In one embodiment, the beam has a top surface and the work bench has a front face that extends below the top surface of the beam. In this embodiment, the work bench has a supplemental shelf extendable from the front face. In one embodiment, the supplemental shelf has a first retracted position in which the shelf is substantially disposed within the work bench and a second extended position in which the shelf is substantially extended from the work bench. The supplemental shelf may be telescopically received within the work bench. The supplemental shelf may also be pivotally connected to the work bench for moving between the retracted and extended positions.

In one embodiment, the supplemental shelf includes a first supplemental shelf section located adjacent the first end of the beam, and a second supplemental shelf section spaced from the first supplemental shelf section and located adjacent the second end of the beam. Workpieces may be stored atop the supplemental shelf for co-locating the workpieces with a power tool, such as a miter saw. Pre-positioning the workpieces on the supplemental shelf will improve efficiency because an operator may remain next to the bench when securing the next workpiece to be cut. As a result, an operator does not have to move away from the work bench to secure the next workpiece to be cut.

In one embodiment, the work bench includes a power cutting tool secured thereto having a cutting blade and a table having a top surface for supporting workpieces during cutting operations. A tool storage container may be releasably attached to the beam adjacent the table, whereby the tool storage container includes a substantially planar workpiece supporting surface that is parallel with the top surface of the table. The workpiece supporting surface preferably provides additional support for workpieces extending beyond the edges of the table. In one embodiment, at least a portion of the workpiece supporting surface is coplanar with the top surface of the table.

In one embodiment of the present invention, a work bench includes a first workpiece support attached to and extending upwardly from the distal end of the first auxiliary arm, the first workpiece support including a planar top surface for supporting a workpiece and an inclined surface that slopes downwardly between the planar top surface and the beam. The work bench may also include a second workpiece support attached to and extending upwardly from the distal end of the second auxiliary arm, the second workpiece support including a planar top surface for supporting a workpiece and an inclined surface that slopes downwardly between the planar top surface and the beam. The inclined surfaces of the first and second workpiece supports desirably confront one another.

In one embodiment of the present invention, a work bench includes a beam for supporting a power tool, the beam having a first end, a second end, and a top surface extending between the first and second ends, legs for supporting the beam over a surface, and a first extension arm extendable from the first end of the beam, the first extension arm including a first main arm that telescopes within the first end of the beam, a first auxiliary arm that telescopes within the first main arm, and a first support leg that is pivotally connected with the auxiliary arm and that telescopes within the main arm. The work bench may also include a second extension arm extendable from the second end of the beam, the second extension arm including a second main arm that telescopes within the second end of the beam, a second auxiliary arm that telescopes within the second main arm, and a second support leg that is connected with the second auxiliary arm and that telescopes within the second main arm. The first and second support legs are desirably pivotable into retracted positions for telescoping into the respective first and second main arms and into extended positions for engaging the surface for stabilizing the work bench over the surface.

In one embodiment, the work bench includes a first workpiece support attached to and extending upwardly from the distal end of the first auxiliary arm, the first workpiece support including a planar top surface for supporting a workpiece and an inclined surface that slopes downwardly between the planar top surface and the beam, and a second workpiece support attached to and extending upwardly from the distal end of the second auxiliary arm, the second workpiece support including a planar top surface for supporting a workpiece and an inclined surface that slopes downwardly between the planar top surface and the beam, whereby the inclined surfaces of the first and second workpiece supports confront one another.

In one embodiment of the present invention, a work bench includes a beam, legs for supporting the beam over a surface, a power tool secured to the beam, the power tool having a table with a top surface for supporting a workpiece during a cutting operation. The work bench includes a tool storage container secured to the beam adjacent the top surface of the table, the tool storage container having a top surface that is coplanar with the top surface of the table. The tool storage container may include a base, a cover hingedly connected to the base for enabling the container to be opened and closed, whereby the base and the cover each have opposing sidewalls that extend over 50% of the height of the container when the container is closed. The height of the side walls enables the container to function effectively regardless of whether the container is secured to the beam in an upright orientation or secured to the beam in an inverted orientation.

In one embodiment, the tool storage container has a side wall with an opening formed therein for removing tools from and placing tools into the container. A rim may surround the opening to prevent tools from accidentally falling out of the container.

These and other preferred embodiments of the present invention will be described in more detail below.

### BRIEF DESCRIPTION OF THE DRAWING

FIGS. 1-4 show a conventional miter saw system including a miter saw and a work bench.

FIGS. 5A-10 show a work bench for supporting a power tool, in accordance with one preferred embodiment of the present invention.

FIGS. 11A-11B show a work bench including a workpiece supporting element, in accordance with one preferred embodiment of the present invention.

FIGS. 12A-13D show a work bench including an auxiliary shelf, in accordance with one preferred embodiment of the present invention.

FIGS. 14A-14B show a work bench including an auxiliary shelf, in accordance with one preferred embodiment of the present invention.

FIG. 15 shows a tool storage container for a work bench, in accordance with one preferred embodiment of the present invention.

FIG. 16A shows a first tool storage container secured atop a beam of a work bench and a second tool storage container secured below the beam of the work bench, in accordance with one embodiment of the present invention.

FIG. 16B shows the first and second tool storage containers of FIG. 16A in open configurations.

FIG. 17 shows a perspective view of the first tool storage container of FIG. 16A.

FIG. 18 shows a tool storage container for a work bench, in accordance with one preferred embodiment of the present invention.

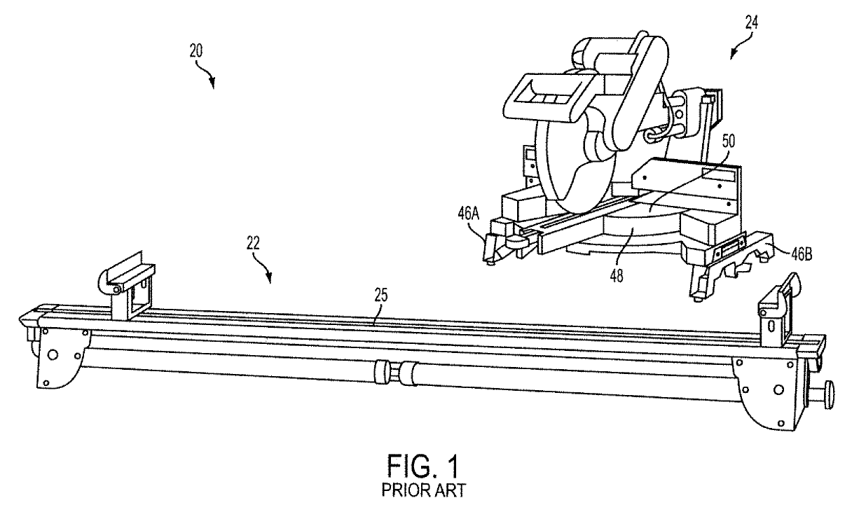

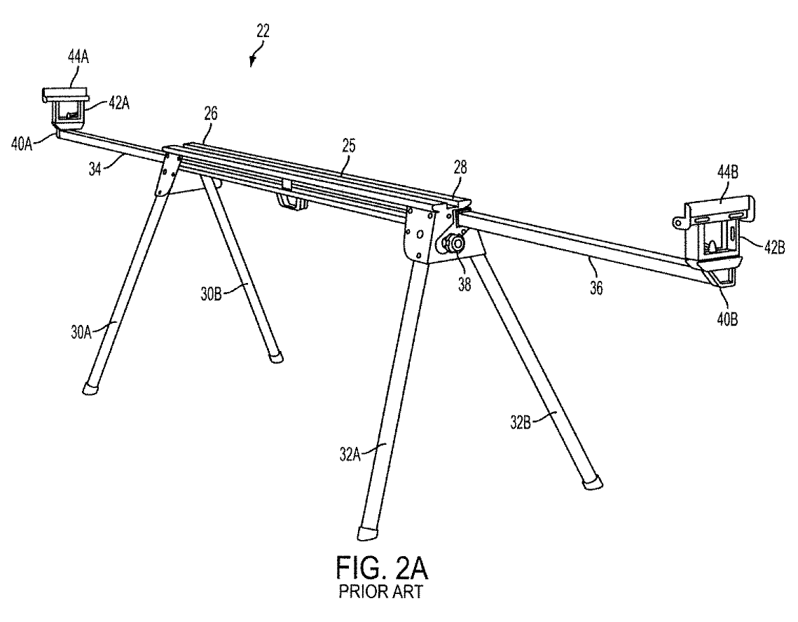

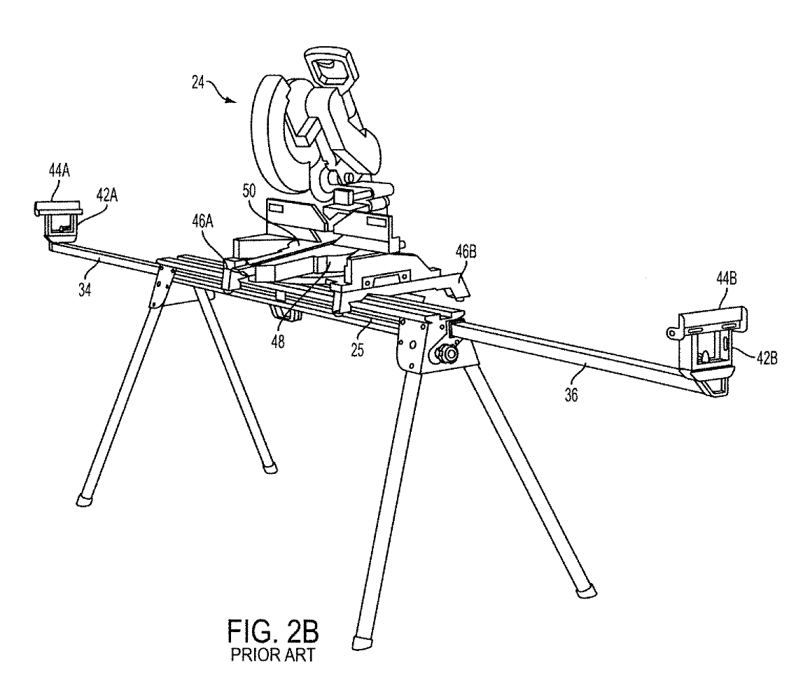

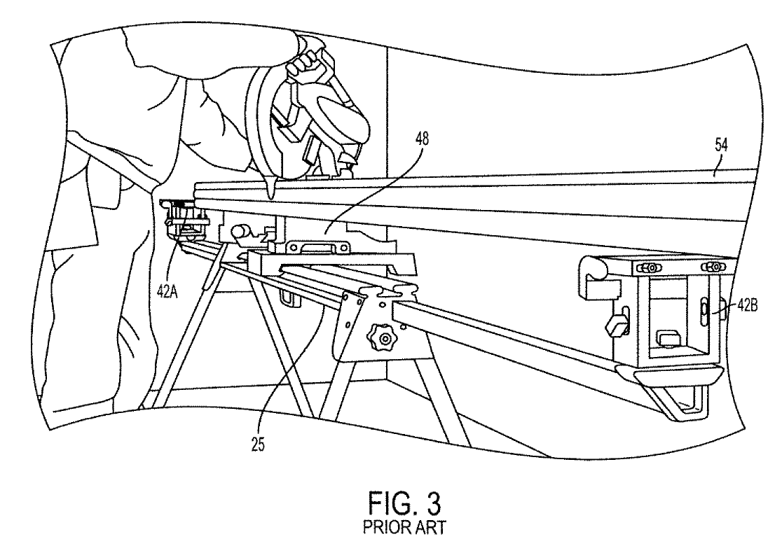

### DETAILED DESCRIPTION

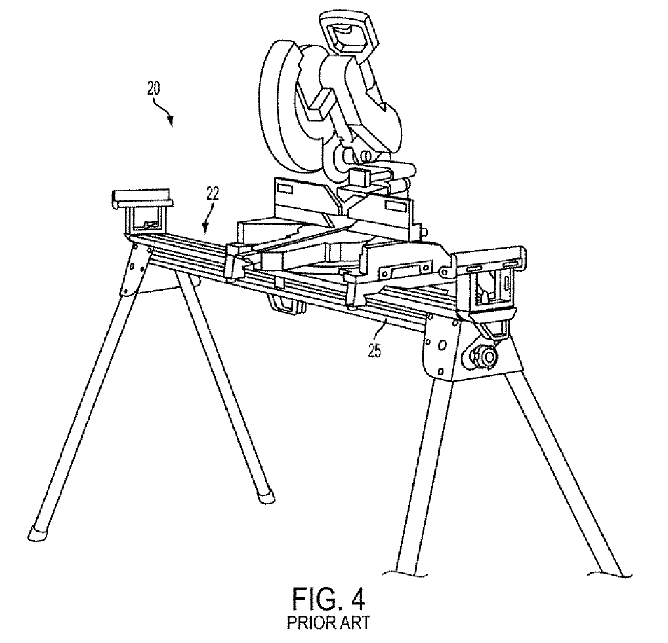

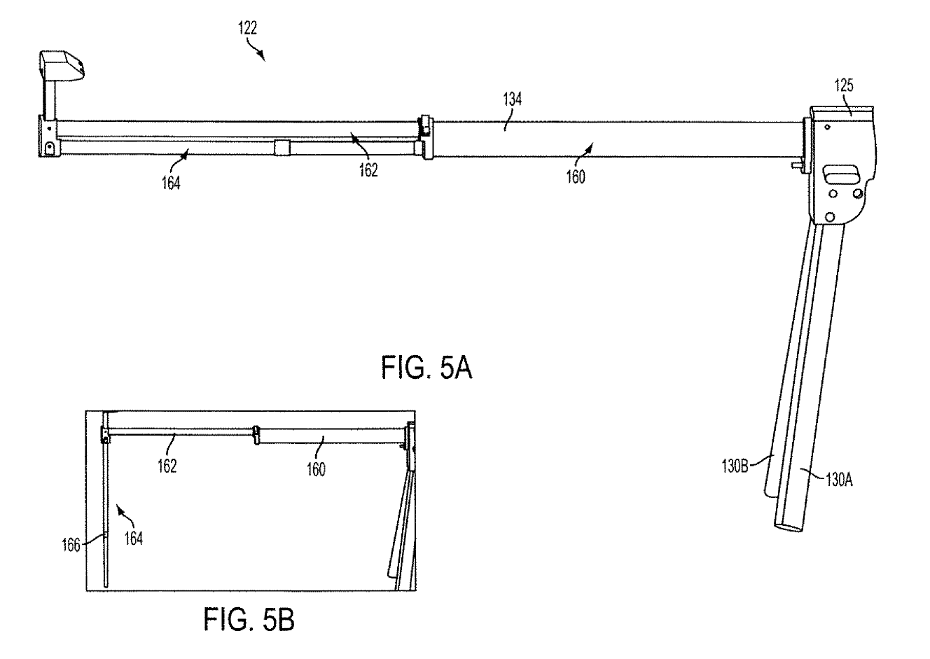

Referring FIG. 5, in accordance with one embodiment of the present invention, a work bench 122 for a power tool, such as a miter saw, includes a main beam 125 having support legs 130A, 130B. In FIG. 5, only the first end of the work bench 122 is shown. In one or more embodiments of the present invention, the second end of the work bench 122 is similar to the first end. In one or more embodiments of the present invention, the work bench may have one or more of the features disclosed in commonly assigned U.S. Pat. Nos. 6,745,804 and 7,036,540, the disclosures of which are hereby incorporated by reference herein.

As shown in FIG. 5, the work bench 122 includes an extendable arm 134 having a main arm 160, an auxiliary arm 162 and a support leg 164. The main arm 160 is telescopically receivable within and extendable from main beam 125. Thus, the main arm 160 may be collapsed inside the main beam 125, fully extended from the main beam 125, or positioned between the fully collapsed state and the fully extended state. The auxiliary arm 162 is telescopically receivable within and extendable from the main arm 160. The support leg 164 is pivotally connected to a distal end of the auxiliary arm 162. When the support leg is moved into the retracted position shown in FIG. 5A, it is substantially parallel with the auxiliary arm and may be received within an opening at the distal end of the main arm.

As used herein, the term “proximal” means the part of an element that is closest to the main beam 125, and the term “distal” means the part of an element that is furthest from the main beam. For example, in FIG. 5A, the proximal end of the main arm is shown adjacent a first end of the main beam 125, and a distal end of the main arm is spaced from the first end of the main beam 125.

Referring FIG. 5B, in one embodiment, the support leg 164 may be moved into a substantially vertical orientation relative to the main arm 160 and the auxiliary arm 162. The support leg 164 desirably includes a locking element 164, such as a locking ring or a length adjusting knob, which may be selectively loosened and tightened for adjusting the length of the support leg 164. The support leg includes a first section having an upper and that is preferably pivotally connected with the distal end of the auxiliary arm 164 and a second section that is telescopically receivable within the first section. The length of the support leg 164 is preferably adjusted so that the lower end of the second section of the support leg engages a surface such as the ground or a floor.

Referring to FIG. 6, in one embodiment of the present invention, the auxiliary arm 162 and the support leg 164 may slide within openings provided at a distal end 170 of the main arm 160. In FIG. 6, the support leg 164 is pivoted to a retracted position so that it extends along an axis that is substantially parallel with the longitudinal axis of the auxiliary arm 162. In the retracted position, the support leg 164 and the auxiliary arm 162 may be slid into the respective openings provided at the distal end of the main arm 160.

The work bench also desirably includes at least one locking element 172, such as a cam lock, that is in communication with an outer surface of the auxiliary arm 162. The locking element 172 may be moved into an unlocked position for enabling the auxiliary arm 162 to slide relative to the main arm 160. When the auxiliary arm 162 has been extended to a desired position relative to the main arm 160, the locking element 172 may be moved into a locked position for locking the auxiliary arm 162 from further movement relative to the main arm 160.

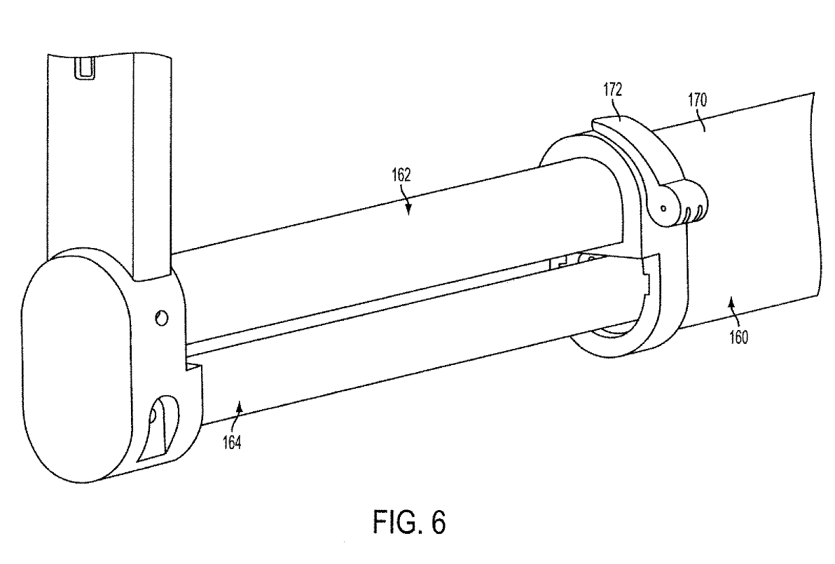

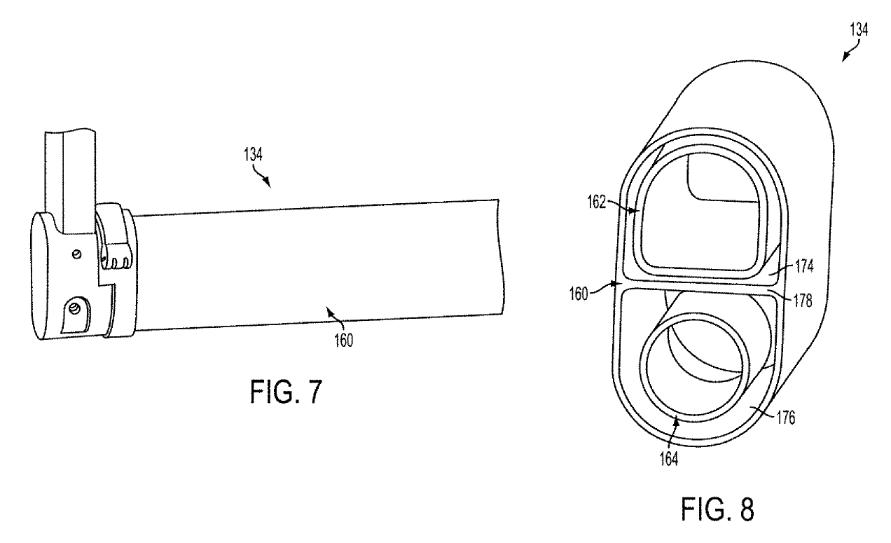

FIG. 7 shows the extendable arm 134 having the auxiliary arm and the support leg fully retracted inside the main arm 160. Referring to FIG. 8, the main arm 160 has an opening accessible at the distal end thereof including a first chamber 174 adapted to receive the auxiliary arm 162 and a second chamber 176 adapted to receive the support leg 164. The first and second chambers 174, 176 are desirably separated by a dividing wall 178. The dividing wall divides the main arm into the two internal chambers 174, 176 for providing separate storage locations for the auxiliary arm and the supporting arm. In one embodiment, the first and second chambers extend the entire length of the main arm 160. In another embodiment, the first and second chambers extend from the distal end toward the proximal end of the main arm 160.

In one embodiment, the auxiliary arm 162 and the support leg 164 are dimensioned for being able to slide easily relative to the respective chambers 174, 176 of the main arm 160. Thus, in one preferred embodiment of the present invention, the outer dimensions of the auxiliary arm 162 and the support leg 164 are smaller than the dimensions of the respective first and second chambers 174, 176.

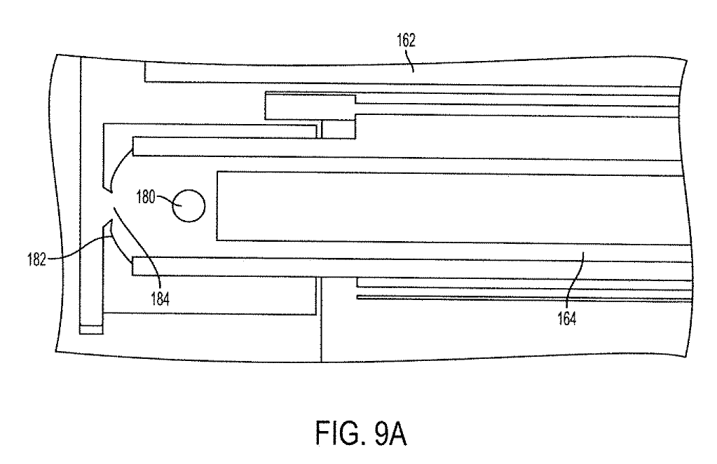

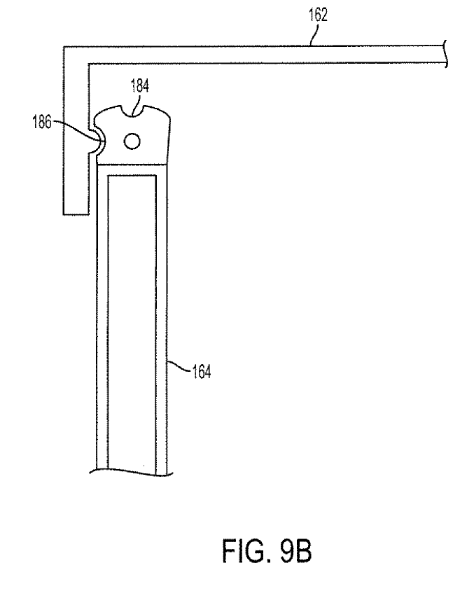

Referring to FIG. 9A, in one preferred embodiment of the present invention, the support leg 164 is permanently connected to a distal end of the auxiliary arm 162 via a pivoting shaft 180 that enables the support leg, after being removed from the second chamber of the main arm, to be selectively pivoted relative to the auxiliary arm. In one embodiment, the support leg 164 includes an upper end 182 having a first detent 184 that normally holds the support leg 164 in a horizontal configuration. The horizontal configuration is shown in FIG. 9A. Referring to FIG. 9B, in one embodiment, the support leg 164 has a second detent 186 that may be engaged for holding the support leg 164 in a substantially vertical orientation relative to the auxiliary leg.

In one embodiment, the support leg may be detachable from the distal end of the auxiliary leg for storage inside the main arm, or at another location on the work bench. In this embodiment, when desired, the upper end of the support leg may be connected with the distal end of the auxiliary arm for stabilizing the ends of the work bench.

Referring to FIG. 10, as noted above, the auxiliary arm 162 and the support leg 164 may be received inside the main arm 160. In one embodiment, the support leg 164 is pivoted to a configuration whereby it extends substantially parallel to the auxiliary arm 162. Once the auxiliary arm 162 and the support leg 164 are positioned parallel to one another, the elements may be inserted inside the respective first and second chamber openings of the main arm 160. As noted above, the work bench may include a locking element 172 having an unlocked position for enabling the auxiliary arm 162 to slide relative to the main arm 160, and a locked position whereby the auxiliary arm 162 is locked from further movement relative to the main arm 160. When desired, the locking element may be once again unlocked for enabling sliding movement of the auxiliary arm relative to the main arm.

Although the present invention is not limited by any particular theory of operation, it is believed that providing an extendable arm having a vertically extendable support leg will afford a work bench having enhanced stability. Moreover, the main arm, auxiliary arm and support leg provide an additional support surface for a workpiece. Moreover, the size of the support surface may be modified by collapsing and extending the auxiliary arm within the main arm, which in turn may be collapsed inside the main beam of the work bench. In one embodiment, first and second arms are extendable from first and second ends of the main beam, whereby each extendable arm has a deployable support leg at the distal end thereof for enhancing the stability of the work bench.

In one embodiment, a work bench has extendable arms that are extendable from both sides of the main beam 125. Each extendable arm 134 includes a main arm 160 and an auxiliary arm 162. The auxiliary arm 162 may be retracted and stored inside the main arm 160, and the main arm may be retracted and stored inside the main beam 125. As a result, the work bench may be collapsed into a unit having a smaller length for storage, transport, and shipment from a factory to a store.

In one embodiment, the work bench, when fully extend, has a length of about 12-17 feet, and more preferably about 12.5 feet. In one embodiment of the present invention, the main beam 125 of the work bench may have a length of about 3.50-5.5 feet, more preferably about 3.75-4.0 feet, and even more preferably about 46″ or 3.83 feet. The main extension arm 160 has an extension length of about 28-36 inches, and more preferably about 32 inches. The auxiliary extension arm 162 has an extension length of about 15-19 inches, and more preferably about 17.5 inches.

In one embodiment, when the main extension arms 160 are fully extended from the main beam 125, each of the main extension arms 160 overlaps with the main beam 125 to provide structural stability to the stand. The exact length of the overlap between the main beam and the main arms 162 may be readily modified for enhancing the structural integrity of the work bench. In one embodiment, the overlap of each of the main extension arms 160 with the main beam is about 10-15″, and more preferably about 12.5″. The auxiliary arms 162 may also overlap with the main arms 160 to provide structural stability.

In one embodiment of the present invention, a work bench has extendable legs including a main arm and an auxiliary arm that provide for a stand that may be extended 2.5-5 times its storage length. For example the stand may have a main beam having a length of about 46 inches for storage, and a length of about 12.5 feet when the extendable arms are fully extended. In another embodiment, however, the work bench may have a length of about 3.5-6 feet when fully collapsed, and a length of at least about 8.75 feet and up to about 30 feet when fully extended, and preferably about 25 feet when fully extended. The above dimensions are merely exemplary in nature, and are not meant to limit the scope of the present invention.

Persons skilled in the art will recognize that the length can be further extended by providing multiple auxiliary arms that retract or telescope within the main extension arm 160 and/or the auxiliary extension arm 162.

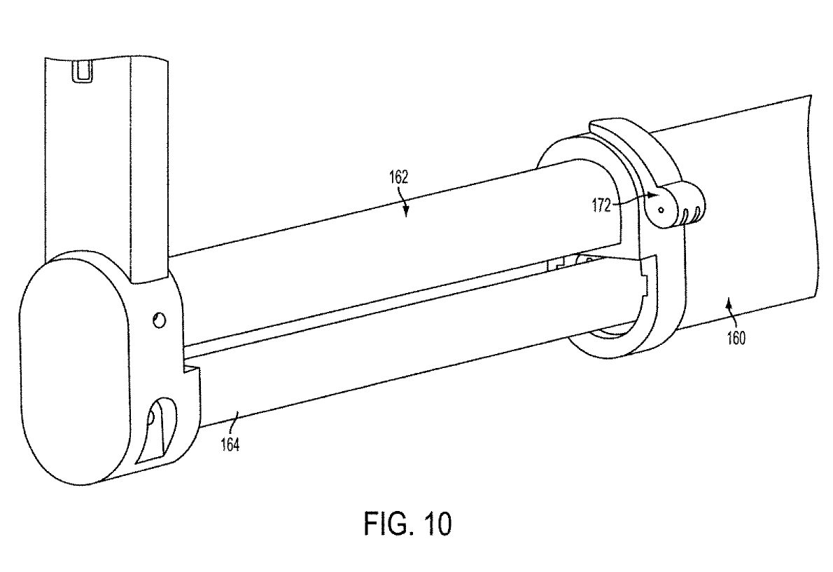

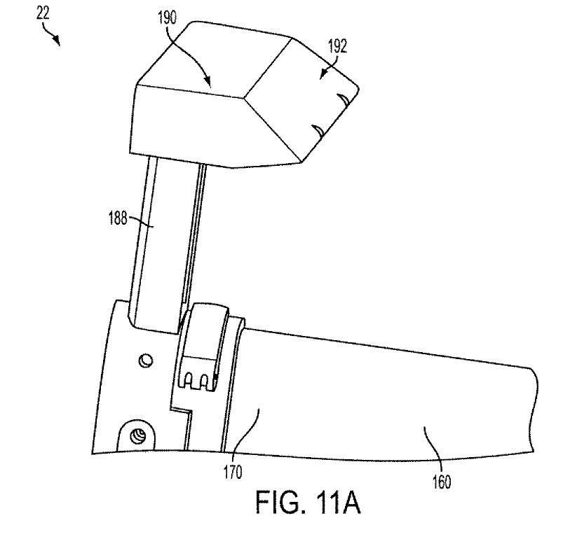

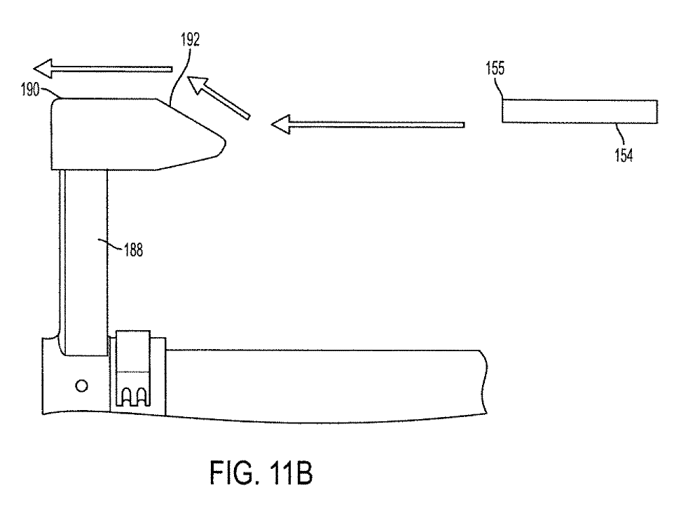

Referring to FIG. 11A, in one embodiment of the present invention, a work bench 22 includes a workpiece support 188 secured to the distal end of the auxiliary arm 162. The workpiece support 188 extends upwardly from the distal end of the auxiliary arm, and includes a substantially flat material support surface 190 and an inclined surface 192 that that slopes downwardly toward the top of the main beam. The inclined or sloping surface 192 desirably provides a ramp for lifting or guiding workpieces atop the material support surface 190. In one embodiment, the height of the workpiece support 188 is adjustable so that the elevation of the material support surface 190 relative to the main beam (not shown) may be modified. In one embodiment of the present invention, a work bench includes a pair of workpiece supports 188. In this embodiment, a first workpiece support is provided at the distal end of a first auxiliary arm and a second workpiece support is provided at the distal end of a second auxiliary arm. The sloping surfaces of the first and second workpiece supports preferably face one another.

Referring to FIG. 11B, in one embodiment, a free end 155 of a workpiece 154 may be moved toward the sloped surface 192 of workpiece support 188. The sloping surface 192 guides the workpiece 154 in the general direction indicated by the arrows shown in FIG. 11B (i.e. atop the material support surface 190). Although the present invention is not limited by any particular theory of operation it is believed that providing a workpiece support 188 having a sloping surface 192 will enable a single operator or as few operators as possible to place the ends of the workpiece 154 atop the material support surface 190. In the embodiment of FIGS. 11A and 11B, a second work support may be placed on another extendable arm provided at the second end of the work bench.

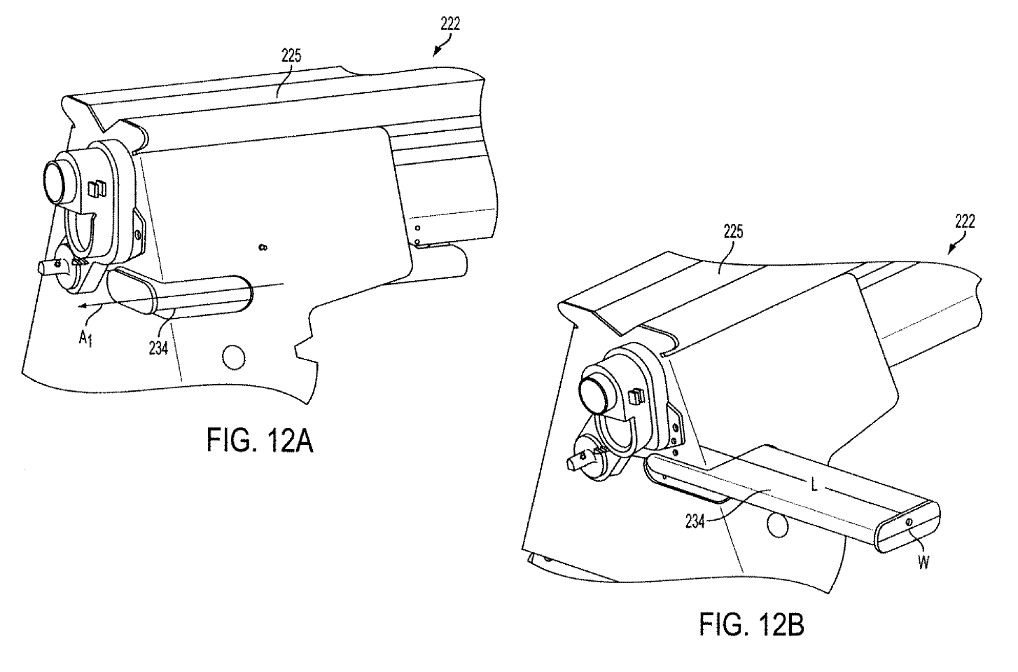

FIGS. 12A and 12B show a work bench 222, in accordance with one preferred embodiment of the present invention. The work bench 222 includes a main support beam 225 having support legs provided at opposite ends thereof. The work bench 222 includes a supplemental shelf including a first shelf section 234 that may be extended from the stand along the axis A₁. Once the first shelf section 234 has been fully extended from the first end of the stand 222, the shelf section 234 may be pivoted to the position shown in FIG. 12B. In one embodiment, the first shelf section 234 has a length L₁ of approximately 5-10 inches and width W₁ of approximately 1-3 inches. In one highly preferred embodiment, the shelf section 234 has a length of about 8 inches and a width of about 2 inches. Although not shown, an opposite, second end of the work bench 222 includes a second shelf section that may be extended and pivoted in a similar manner as the first shelf section 234. The first and second extendable arms preferably extend from the same side of the work bench (e.g. the front face) to provide a supplemental shelf for storing workpieces. An operation may place workpieces directly atop the first and second shelf sections so as to more closely store the workpieces adjacent a power tool, and to improve accessibility of the workpieces during cutting operations. In another embodiment, a planar structure such as a piece of wood may be placed atop or attached to the first and second extendable shelf sections to provide a support surface for workpieces. In one embodiment, tools may also be placed atop the planar structure.

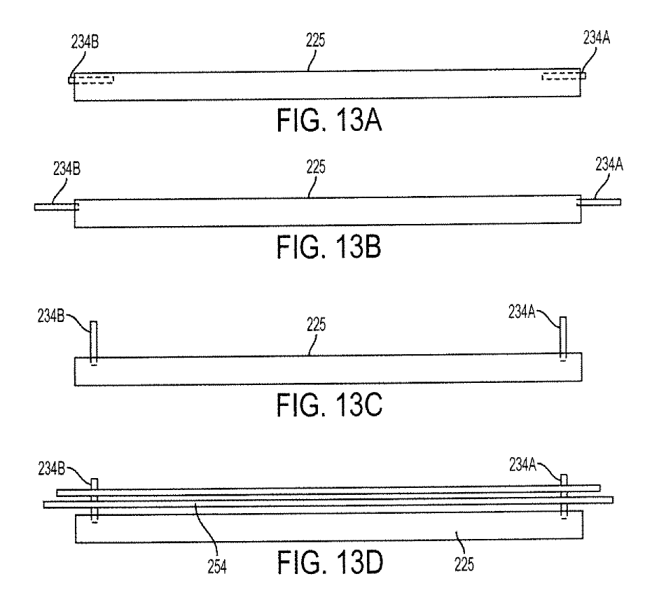

FIGS. 13A-13D show the first and second shelf sections 234A, 234B being placed into an extended position for supporting workpieces. In FIG. 13A, the first and second extendable shelf sections 234A, 234AB are retracted inside the main beam 225. Referring to FIG. 13B, the first and second shelf sections are extendable from the opposite ends of the main beam 225. Referring to FIG. 13C, the first and second shelf sections 234A, 234B are rotatable toward one another so that the respective shelf sections extend from the same face of the main beam 225. Referring to FIG. 13D, one or more workpieces 254 may be supported atop the first and second shelf sections 234A, 234B. The first and second shelf sections cooperate to form a supplemental shelf for storing workpieces, thereby enabling an operator to pre-position workpieces adjacent a power tool during cutting operations so as to improve efficiency during cutting operations.

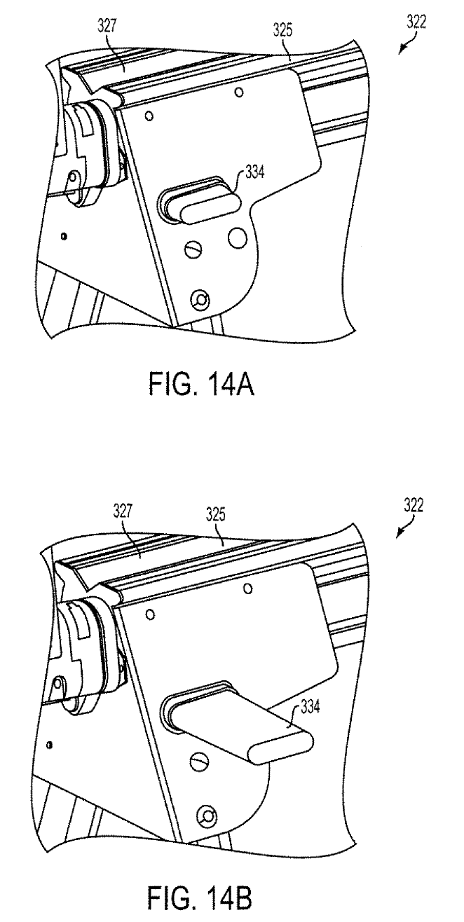

Referring to FIGS. 14A and 14B, in one embodiment of the present invention, a work bench 322 includes a main support beam 325 having a first end 327 and a second end (not shown). The work bench 322 includes a first shelf section 334 that may be selectively retracted inside the first end 327 (FIG. 13A) and extended from the first end 327 (FIG. 13B). The second end (not shown) of the main beam 325 has a second shelf section that is similar in design to the first shelf section 334. The first and second shelf sections cooperatively form a supplemental shelf, similar to the supplemental shelf shown and described above in FIGS. 13A and 13B.

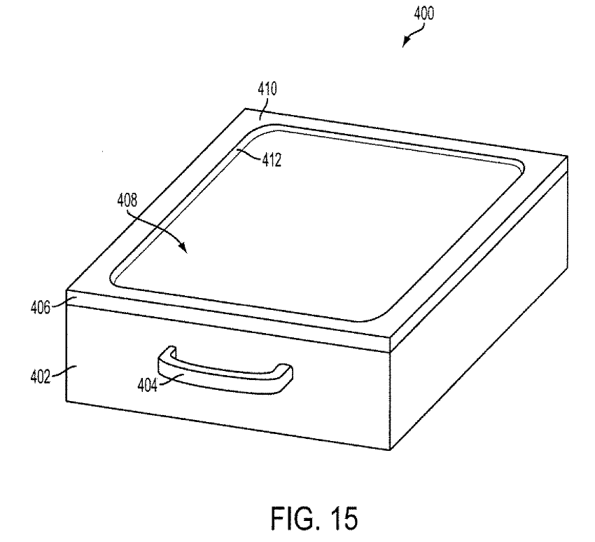

Referring to FIG. 15, in one embodiment of the present invention, a miter saw system includes a tool storage container 400 having a front wall 402 with a handle 404 extending therefrom. The handle 404 may be used for carrying the tool storage container between locations. The tool storage container 400 includes a top cover 406 having a work surface 408. The top cover 406 is preferably made of a durable material that may support tools and workpieces during cutting operations. When worn or damaged, the top cover may be removed and replaced with a new top cover. The top cover 406 includes a raised rim 410 that defines an interior peripheral wall 412 that surrounds the work supporting surface 408. The raised rim 410 and the peripheral wall 412 prevent any items atop the work support surface 408 from sliding, moving or falling off the work support surface 408. In one embodiment, the top cover may comprise a completely planar surface that does not have the centrally depressed area shown in FIG. 15.

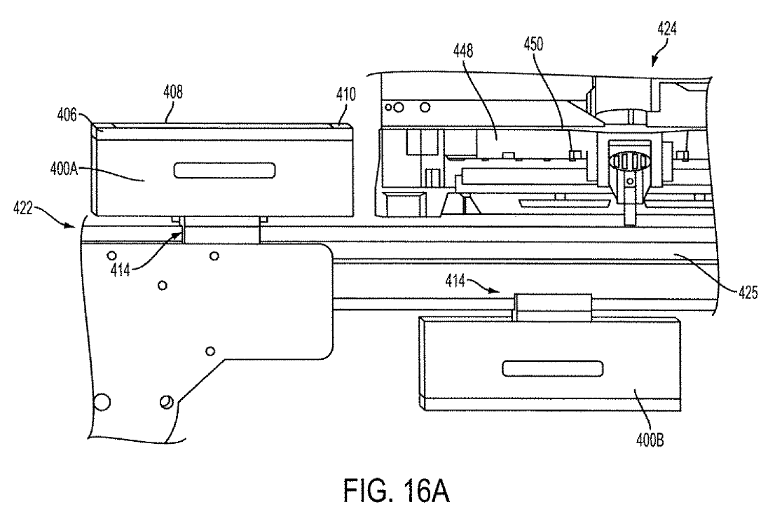

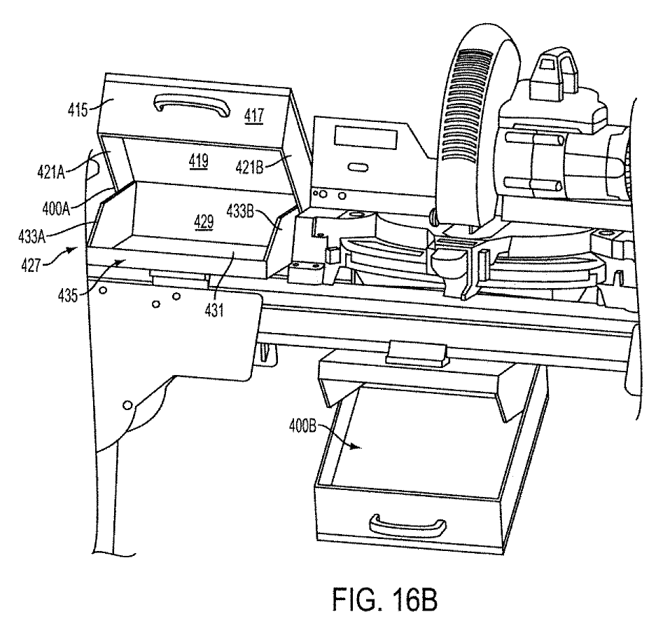

Referring to FIG. 16A, in one embodiment of the present invention, the tool storage container 400 includes at least one attachment clip 414 that enables the tool storage container 400 to be secured to the main support beam 425 of a work bench 422. As shown in FIG. 16A, a first tool storage container 400A may be secured over the main support beam 425 in an upright orientation, and a second tool storage container 400B may be secured underneath the main support beam 425 in an inverted orientation.

The top cover 406 includes the workpiece supporting surface 408 for supporting tools and/or workpieces thereon. In one embodiment, the outer rim 410 of the cover includes a planar surface that is co-planar with the top surface 450 of the table 448 of the power tool 424 (e.g. a miter saw). The co-planarity enables the top surface of the rim 410 to provide an auxiliary support surface for workpieces that extend beyond the outer edge of the table 448.

In one embodiment of the present invention, the tool storage containers have a first closed position (FIG. 16A) for reliably securing one or more tools within an interior chamber. The tool storage containers 400A, 400B may be opened, as shown in FIG. 16B. The first tool storage container 400A includes an upper part 415 having a front wall 417, a top wall 419, and opposing side walls 421A, 421B. The front wall 417, top wall 419, and opposing side walls 421A, 421B preferably cooperate to form an enclosed space for holding tools therein. The tool storage container 400A includes a lower part 427 having a rear wall 429, a bottom wall 431, opposing side wails 433A, 433B, and a front wall 435 that opposes the rear wall 429. The front wall 429, bottom wall 431, opposing side walls 433A, 433B and rear wail 435 desirably cooperate to form a second enclosed space for containing tools. The heights of the opposing side, front, and rear walls on both the upper and lower parts of the tool storage containers are preferably sufficient so that each upper and lower part could serve as a separate container. This structure enables the tool storage containers of the present invention to be used in either an upright orientation in which the container is attached above the main support beam, or an inverted orientation in which the container is attached below the main support beam. In either configuration, the tool storage container may be opened and the tools will not tumble out of the opened container. This benefit is due in part to the fact that each of the upper and lower parts 415, 427 has surrounding walls of sufficient height to contain tools within the respective part. Thus, each of the upper and lower parts of the containers may, by itself, serve as a container for tools.

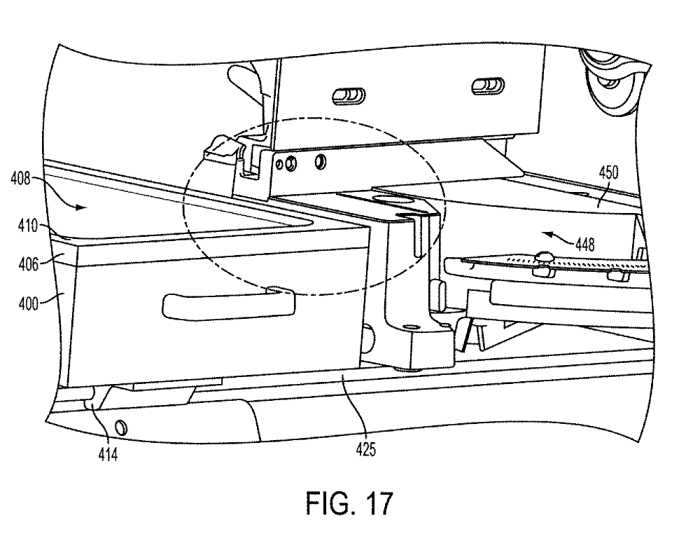

Referring to FIG. 17, the tool storage container 400 may be secured atop main support beam 425 using one or more attachment clips 414. The attachments clips are preferably designed to enable the storage container to be readily removed from a beam and then reattached to a beam when desired. The easy removal of the storage containers from the beam enables the containers to be removed from a beam at one location, moved to a different site, and reattached to a beam at the new site. In one embodiment, after the tool storage container 400 has been attached to the main beam 425, the top surface of the rim 410 is preferably co-planar with the top surface 450 of table 448. The top work surface 408 preferably provides an additional work space for cutting workpieces adjacent the table top 448. As a result, an operator does not have to move away from the power tool and the stand to perform other operations on workpieces (e.g. using a coping saw to trim a workpiece). In one embodiment, the height of the top surface of the cover 406 relative to the top surface 450 of the table 448 may be modified to provide adjacent surface that are co-planar. The tool storage container 400 may be opened to the configuration shown in FIG. 16B for removing and/or storing tools therein. The tool storage container may then be closed to the configuration shown in FIG. 17 to provide the auxiliary work surface noted above.

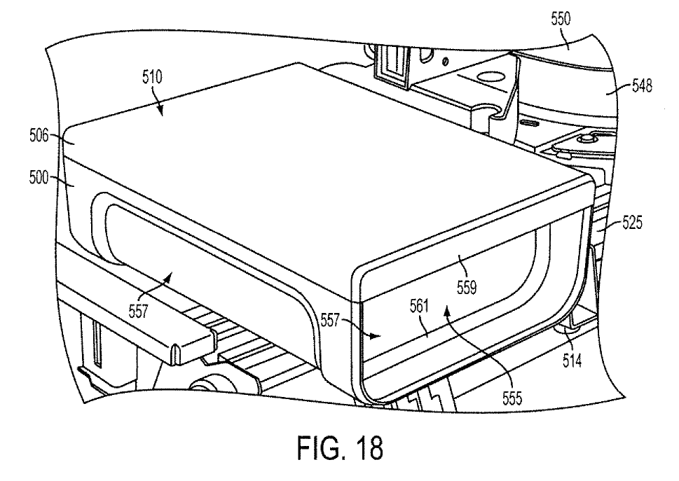

Referring to FIG. 18, in one embodiment of the present invention, a tool storage container 500 is securable to a beam 525 of a work bench using one or more attachment clips 514. The tool storage container may be secured atop the beam or below the beam. The tool storage container 500 desirably has at least one opening 555 provided in a side wall thereof. The opening 555 enables an operator to easily store and remove tools from inside the tool storage container 500, without having to open or close a container. The tool storage container 500 preferably includes a top cover 506 having a top surface 510 that is substantially co-planar with the top surface 550 of the table 548. The sidewalls of the tool storage container 500 may have depressions 557 formed therein that enable the tool storage container to be positioned closer to the table 548. The top cover 506 includes a vertically extending wall 559 that provides a rim around the opening 555. As a result, the tool storage container 500 may be inverted for attachment under the beam 525, and the rim 559 will prevent tools from accidentally falling out of the tool storage container. The tool storage container may also include additional rims around the openings to contain tools within the container. In one embodiment, a tool storage container has a second rim 561 that extends along the opening 555 to prevent tools and/or other items from falling out of the opening. The second rim 561 will prevent the items from falling out of the opening when the tool storage container 500 is in the upright orientation shown in FIG. 18.

While the foregoing is directed to embodiments of the present invention, persons skilled in the art will recognize that other and further embodiments of the invention may be devised without departing from the basic scope thereof. These additions and/or alterations are considered to be equivalents of the present invention.

What is claimed is:

1. A work bench comprising:
a beam having a first end and a second end;
a first leg for supporting said beam;
a first bracket connected to the first leg and the beam, the first bracket being adjacent to the first end of the beam; and
a first extension arm extendable from the first end of the beam.

2. The work bench of claim 1, wherein the first extension arm comprises a main arm telescoping within the beam, and an auxiliary arm telescoping within the main arm.

3. The work bench of claim 2, wherein the first extension arm further comprises a support leg connected to the auxiliary arm and telescoping within the main arm.

4. The work bench of claim 3, wherein the support leg is pivotally connected to the auxiliary arm.

5. The work bench of claim 3, wherein the support leg is length adjustable.

6. The work bench of claim 5, wherein the support leg comprises:
a first section pivotally connected to the auxiliary arm;
a second section that telescopes within the first section; and
a locking element in contact with the support leg having an unlocked position for adjusting the length of the support leg and a lock position for affixing the length of the support leg.

7. The work bench of claim 1, further comprising:
a second extension arm extendable from the second end of the beam;
a first workpiece support attached to and extending upwardly from the first auxiliary arm, the first workpiece support including a first planar top surface for supporting a workpiece and an inclined surface that slopes downwardly between the first planar top surface and the beam; and
a second workpiece support attached to and extending upwardly from the second auxiliary arm, the second workpiece support including a second planar top surface for supporting a workpiece and an inclined surface that slopes downwardly between the second planar top surface and the beam.

8. The work bench of claim 1, wherein the beam has a top surface and the first bracket has a first supplemental shelf, the first supplemental shelf having a first retracted position in which the first supplemental shelf is substantially disposed within the first bracket, and a second extended position in which the first supplemental shelf is substantially extend from the first bracket.

9. The work bench of claim 8, further comprising:
a second bracket connected to the beam, the second bracket being adjacent to the second end of the beam;
a second leg connected to the second bracket; and
a second supplemental shelf connected to the second bracket, the second supplemental shelf having a first retracted position in which the second supplemental shelf is substantially disposed within the second bracket, and a second extended position in which the second supplemental shelf is substantially extend from the second bracket.

10. The work bench of claim 1, further comprising a storage container attachable to the beam, the storage container including a substantially planar workpiece supporting surface.

11. The work bench of claim 10, further comprising a power tool having a blade and a table for supporting a workpiece during a cutting operation.

12. The work bench of claim 11, wherein the supporting surface is substantially coplanar with the table.

13. The work bench of claim 10, Wherein the storage container is attachable to at least one of a top surface and a bottom surface of the beam.
